(19) United States
(12) Patent Application Publication
(10) Pub. No.: US 2026/0094218 A1
(43) Pub. Date: Apr. 2, 2026

(54) Machine Learning Systems and Methods for Property Estimation Anomaly Detection

(71) Applicant: Xactware Solutions, Inc., Lehi, UT (US)

(72) Inventors: David Baryudin, Medfield, MA (US); Amberlee Sorensen, Pleasant Grove, UT (US); Haowei Song, San Rafael, CA (US)

(73) Assignee: Xactware Solutions, Inc., Lehi, UT (US)

(21) Appl. No.: 19/347,115

(22) Filed: Oct. 1, 2025

Related U.S. Application Data
(60) Provisional application No. 63/702,062, filed on Oct. 1, 2024.

(51) Int. Cl. G06Q 40/08

(52) U.S. Cl. CPC G06Q 40/09; G06Q 40/084

(57) ABSTRACT

Machine learning systems and methods for property estimate anomaly detection are provided. The system receives property estimation data from a data source and processes the property estimation data to extract line item information from the property estimation data. The line item information, along with majority estimate information, is then processed by an automated anomaly detection process which performs majority estimate unit detection, line item quantity detection, and line item cluster detection on the extracted line item information using a plurality of machine learning models. The system then processes the majority estimate unit detection, line item quantity detection, and line item cluster detection to identify anomalous data in the line item information, and generates and displays a summary of the anomalous data in a graphical user interface screen of a claims estimation software application.

### RELATED APPLICATIONS

This application claims priority to U.S. Provisional Application Ser. No. 63/702,062 filed on Oct. 1, 2024, the entire disclosure of which is expressly incorporated herein by reference.

### BACKGROUND

### Technical Field

The present disclosure relates generally to the field of machine learning. More specifically, the present disclosure relates to machine learning systems and methods for property estimation anomaly detection.

### RELATED ART

In the insurance claims processing field, claims estimation software applications such as the XACTIMATE claims processing software application by Xactimate Solutions, Inc. are often used to process insurance claims. While these software applications are extremely helpful in assisting insurance professionals with rapidly assessing and processing insurance claims, there are sometimes anomalies in property estimation data entered by users of such systems. As a result, insurance claims can sometimes include anomalous data, which results in delays in processing insurance claims. It would therefore be desirable to provide automated systems, based on machine learning and artificial intelligence technology, which automatically detects anomalous property estimation data at the point of data entry/capture, so as to eradicate such anomalous data from being processed by claims estimation software applications.

Accordingly, what would be desirable, but have not yet been provided, are machine learning systems and methods for property estimation anomaly detection which address the foregoing and other needs.

### SUMMARY

The present disclosure relates to machine learning systems and methods for property estimate anomaly detection. The system receives property estimation data from a data source (e.g., from a user operating a claims estimation software application) and processes the property estimation data to extract line item information from the property estimation data. The line item information, along with majority estimate information, is then processed by an automated anomaly detection process which performs majority estimate unit detection, line item quantity detection, and line item cluster detection on the extracted line item information using a plurality of machine learning models. The system then processes the majority estimate unit detection, line item quantity detection, and line item cluster detection to identify anomalous data in the line item information, and generates and displays a summary of the anomalous data in a graphical user interface screen of a claims estimation software application, thereby automatically detecting the anomalous data and highlighting it for the user prior to completion of a property estimation project being conducted by the user using the claims estimation software application.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the machine learning system of the present invention;

FIG. 2 diagram illustrating processing steps carried out by the systems and methods of the present disclosure for ingestion and initial processing of claims data;

FIG. 3 is a diagram illustrating overall processing steps carried out by the systems and methods of the present disclosure;

FIGS. 4-6 are diagrams illustrating operation of the systems and methods of the present disclosure on insurance claim data;

FIG. 7 is a diagram illustrating implementation of the systems and methods of the present disclosure in a cloud computing environment;

FIG. 8 illustrates screenshots of user interface screens generated by the systems and methods of the present disclosure; and

FIGS. 9-11 are flowcharts illustrating overall processing steps carried out by the models of the systems and methods of the present disclosure.

### DETAILED DESCRIPTION

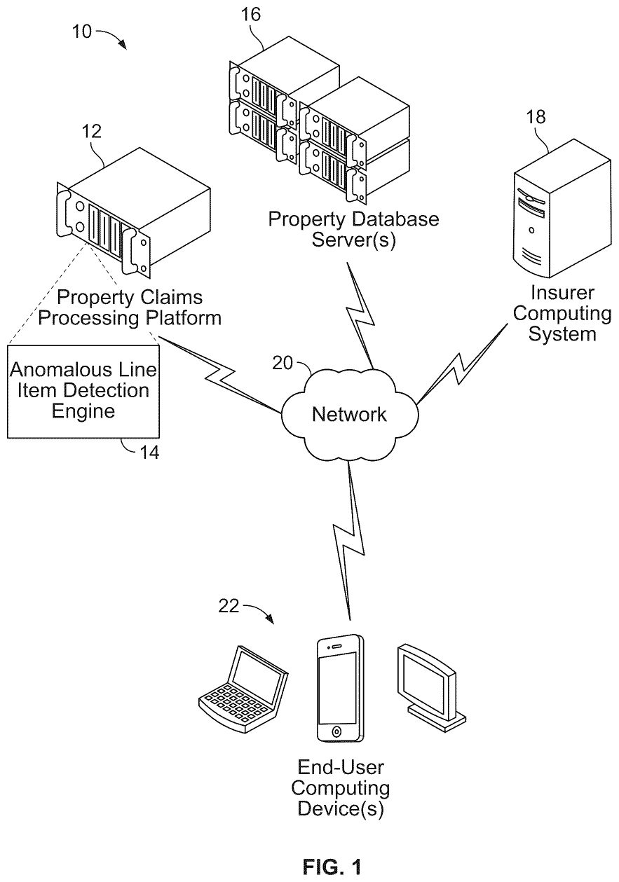

The present disclosure relates to machine learning systems and methods for property estimation anomaly detection, as set forth in detail below in connection with FIGS. 1-11.

FIG. 1 is a diagram, indicated generally at 10, illustrating the machine learning system of the present invention. The system 10 includes a property claims processing computing platform 12 that executes an anomalous line item detection software engine 14 to detect and flag one or more anomalies in property estimation data using a customized machine learning process. The computing platform 12 can obtain the property estimation data from one or more property database servers 16, which could be in communication with the property claims processing computing platform 12 via a communications network 20. Additionally, the property claims processing computing platform 12 could communicate with one or more insurer computing systems 18 and/or one or more end-user computing devices 22 via the communications network 20.

The property claims processing platform 12 processes property estimation data that is captured and stored using a suitable property claims estimation software application, such as the XACTIMATE insurance claims processing platform by XACTWARE SOLUTIONS, INC., and, utilizing customized machine learning processing, detects and identifies anomalous estimate lines that have been entered into the insurance claims processing platform or software. As will be discussed in greater detail below, the system 10 (including the processing platform 12 and software engine 14) continuously analyzes line items that are used in estimate by mining line item associations, segmentation, volume and quantity distributions across multiple years of stored insurance claims data, using machine learning. Utilizing room type, type of loss, and location 10, the system further refines anomaly detection to better encompass historical line item association patterns and distributions. As a result, the system 10 performs advanced outlier detection and anomaly identification. The platform 12, could include any suitable computing platform including, but not limited to, a server, a cloud computing platform, a personal computer, a mobile device (e.g., smart phone), or any other suitable computing platform. The engine 14 could be coded in any suitable high- or low-level computing language, including, but not limited to, C, C++, C#, Java, Python, or any other suitable programming language. Moreover, the end-user computing devices 22 could include, but are not limited to, personal computer, mobile devices (e.g., smart phones), laptop computers, or any other suitable computing devices.

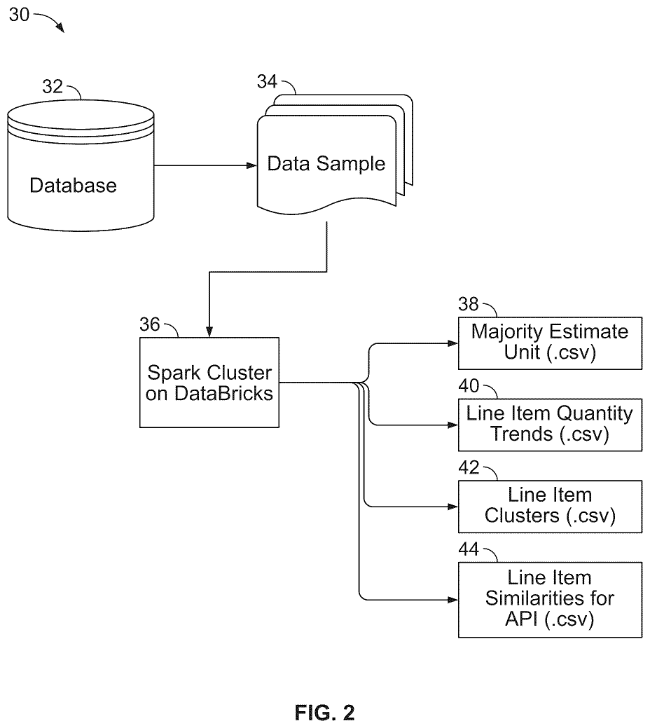

FIG. 2 diagram illustrating processing steps, indicated generally at 30, carried out by the systems and methods of the present disclosure for ingestion and initial processing of claims data. In step 34, the system obtains a plurality of data samples from the database 32 (which could be stored on the database server 16 of FIG. 1 and/or hosted by a suitable cloud-based data warehouse such as the Snowflake data warehouse), which could include, for example, 5 years of stored insurance claims data (or any other suitable quantity/duration of stored insurance claims data). Next, in step 36, the system processes the plurality of data samples to extract the outputs 38-44, which could include, but are not limited to, a majority estimate unit output 38, line item quantity trends output 40, line item clusters output 42, and line item similarities for application programming interface (API) output 44. The outputs 38-44 could be conveyed as comma-separated value (CSV) text files, or in any other suitable format. Step 36 could be performed using one or more Apache “Spark” clusters (groups of computers that are treated as a single computer) as well as the “Databricks” cloud-based, open-source analytics and artificial intelligence (AI) platform.

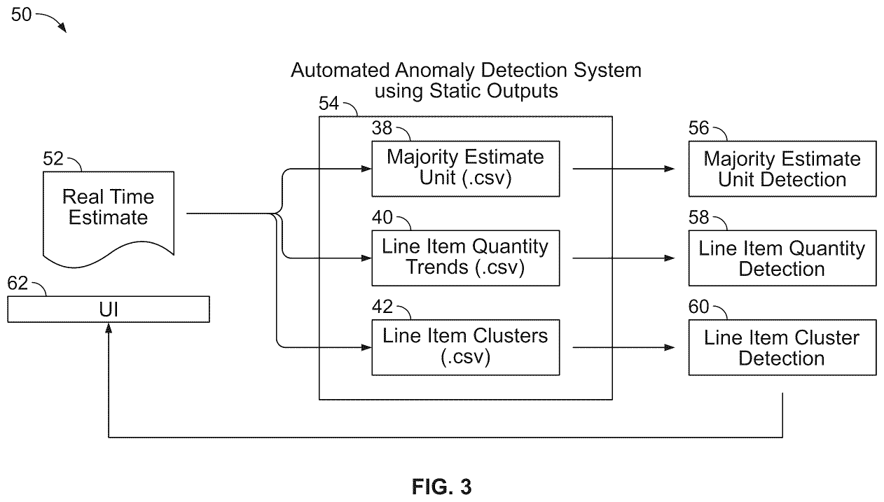

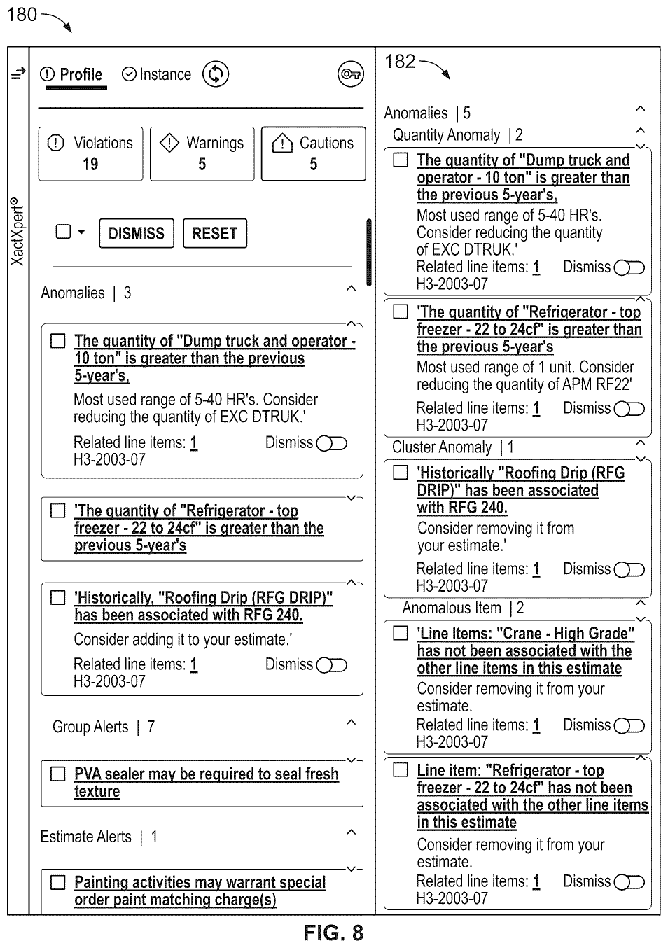

FIG. 3 is a diagram, indicated generally at 50, illustrating overall processing steps carried out by the systems and methods of the present disclosure. In step 52, one or more real-time property estimates is obtained by the system (e.g., from the database server 14 of FIG. 1). Then, in process 54, the system performs automated anomaly detection using the outputs 38-42 of FIG. 2. Process 54 produces a majority estimate unit detection report 56, a line item quality detection report 58, and a line item cluster detection report 60, each of which can be conveyed to a user of the system in one or more user interface screens 62 (examples of which are shown in FIG. 8 and described in more detail below).

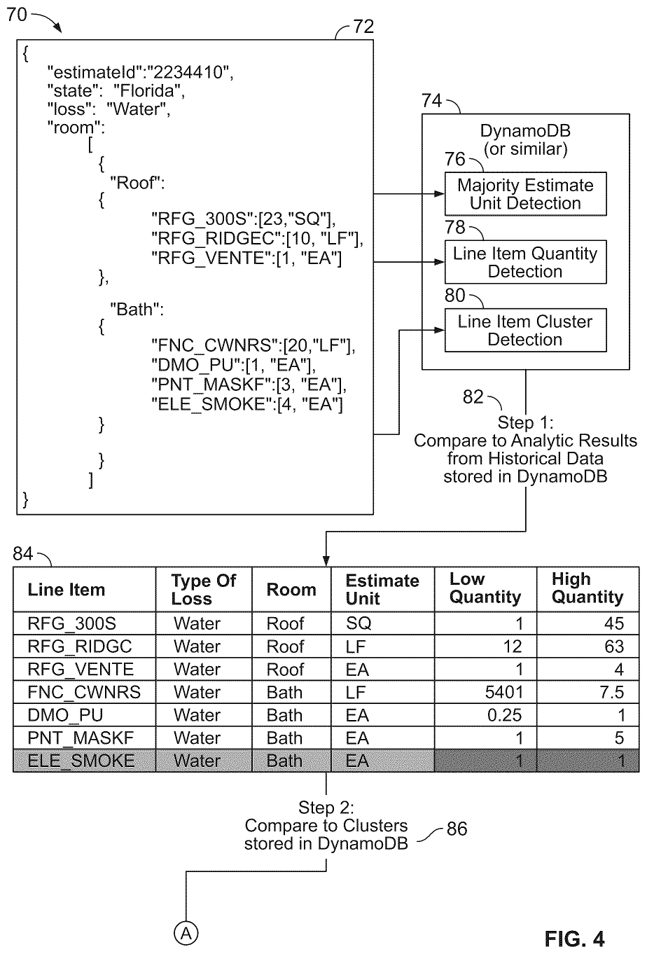

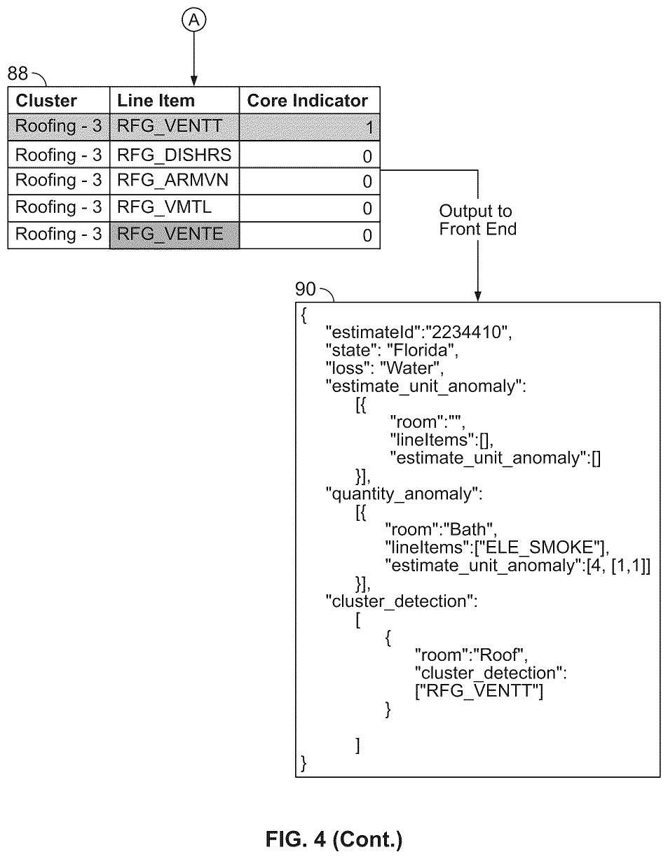

FIGS. 4-6 are diagrams illustrating operation of the systems and methods of the present disclosure on insurance claim data. More specifically, FIG. 4 is a diagram 70 illustrating processing of an estimate 72 by the system. The estimate 72 (which includes various data fields such as an estimate identifier, state identifier, loss type identifier, and details about a structure that is the subject of an insurance claim, such as a room type, roof identifier, bath information, etc.). is processed by a key-value, non-relational “NoSQL” database service such as the DynamoDB database service provided by Amazon, Inc., which has been programmed in accordance with the present disclosure to execute majority estimate unit detection process 76, line item quantity detection process 78, and line item cluster detection process 80. Then, in step 82, the system first compares the results generated by processes 76-80 to analytic results performed on historical data stored in the database, generating first anomaly detection output 84. For example, information such as the state, loss type, and line item information is cross-checked against the historical data, and the estimate unit and quantities of inputted line items are validated against the historical data so that any anomalous data is identified and flagged in the output 84. In the output 84, the line item “ELE_SMOKE” has a quantity value which is higher than historical quantity values for the same type of loss and room type, and as such, the line item is flagged by the system as anomalous. Next, in step 86, the system compares the output 84 to clusters stored in the database, producing output 88. More specifically, the estimate is validated against the line item clusteres to determine if the estimate is missing any common line items. Since the line item “RFG_VENTE” was selected and is part of the “Roofing-3” cluster, the system checks to see if any other line items are commonly seen together with the RFG_VENTE line item. For example, the line item “RFG_VENTT” is a known high-volume (core indicator) line item that is often associated with the line item RFG_VENTE, and if it is missing from the estimate, the system flags (tags) the item as missing. The final output is then communicated in step 90 (which could comprise a message indicating the estimate identifier, state identifier, loss identifier, summary of unit anomalies found by the system, summary of quantity anomalies found by the system, and results of cluster detection performed by the system.

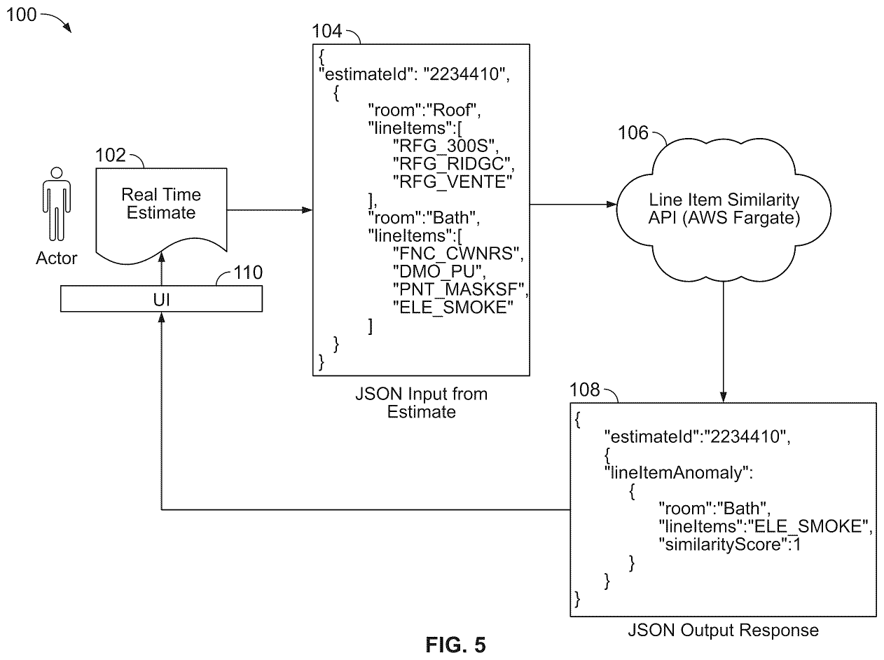

FIG. 5 is a diagram, indicated generally at 100, illustrating Javascript Object Notation (JSON) messaging performed by the system. In step 102, when a user completes and estimate, the system sends the room and line item information for processing by a line item similarity process 106 (which could be executed on a suitable cloud processing platform, such as Amazon AWS Fargate) via a JSON input message 104 which functions as an API call to the process 106. The process 106 performs the line item anomaly detection as disclosed herein, and outputs a JSON output response 108 that contains the room and line items that are anomalous along with a similarity score which categorizes the anomaly. The output response 108 can then be visualized in a user interface (UI) screen, such as the screens discussed below in connection with FIG. 8.

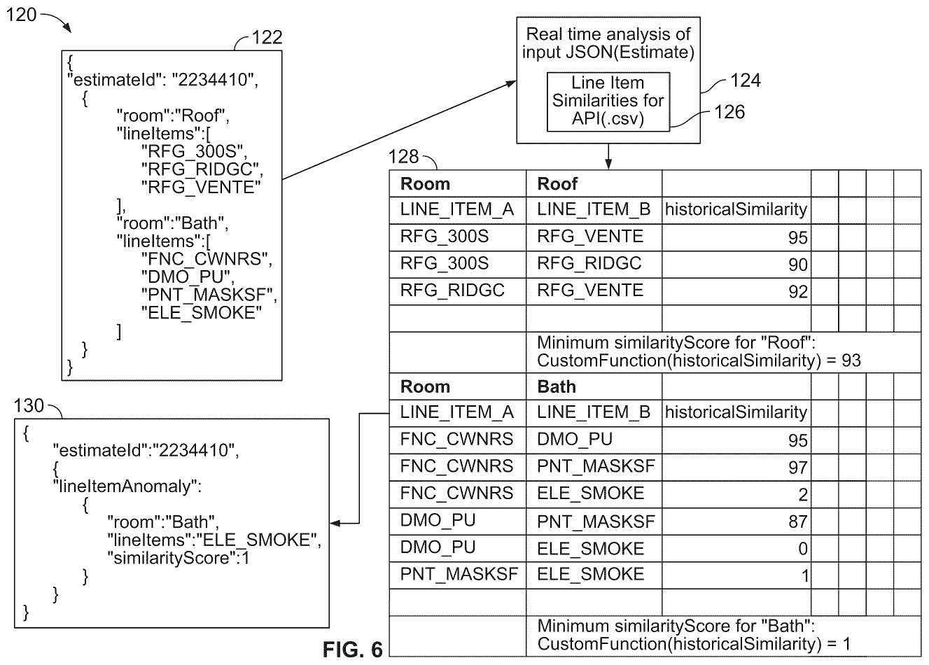

FIG. 6 is a diagram, indicated generally at 120, illustrating line item anomaly detection being performed by the systems and methods of the present disclosure. An input JSON request 122 is received and processed in real time by process 124, and includes a room and subsequent line item information. The process 124 outputs line item similarities 126 (which could be in the form of a CSV file), which are then processed in step 128 to calculate a final similarity score for the room, which is then output as an output JSON response 130. The line item similarities 126 (which could be generated in response to an API call to the system) are evaluated in step 128 to evaluate the likelihood that line items are seen together in an estimate, based on historical data. The line items are cross-joined to each other and their historical similarities are calculated. In the example shown in step 128, the line item “ELE_SMOKE” has a historically low similarity to other line items in the room “Bath” and, therefore, is seen in the output JSON response 130 with a score of 1.

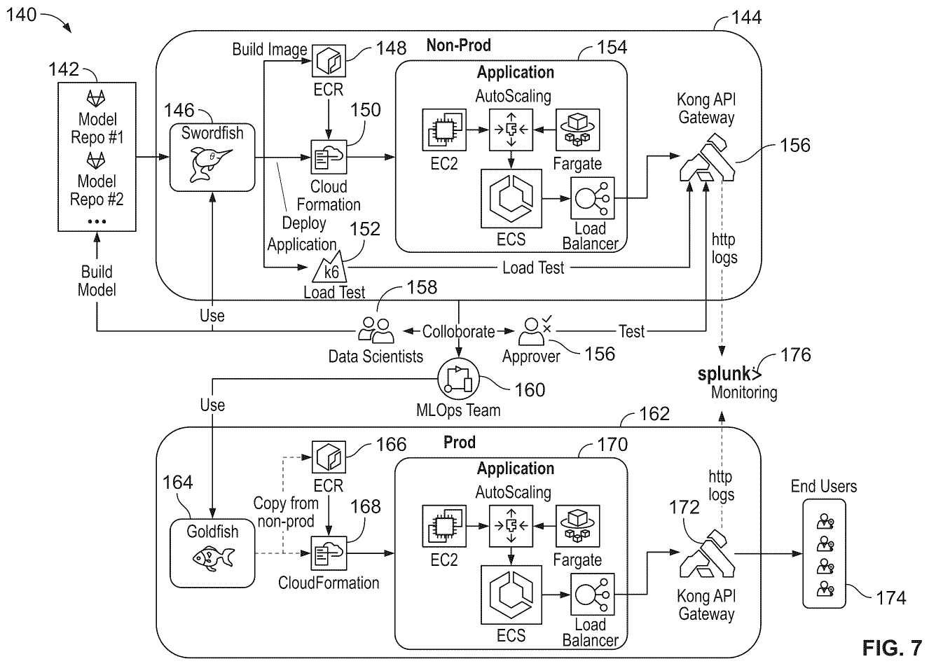

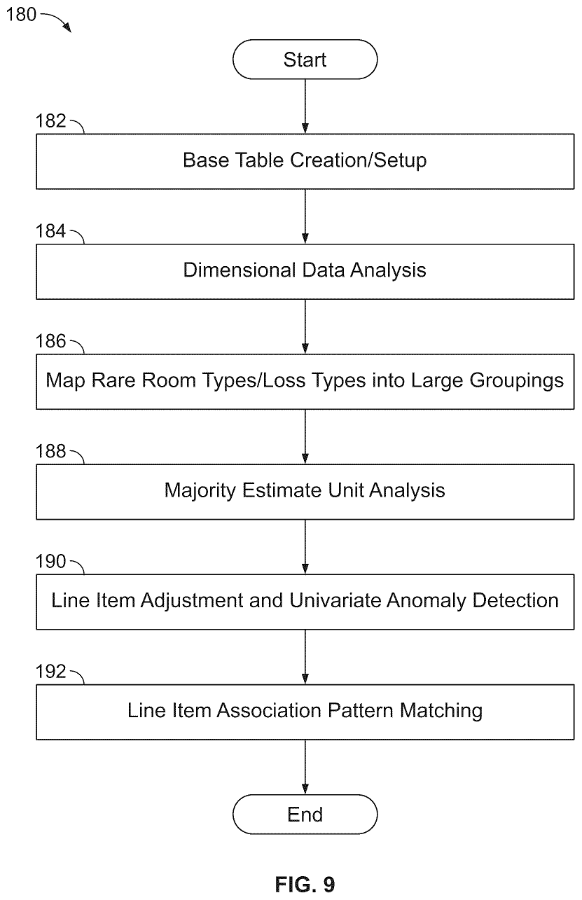

FIG. 7 is a diagram, indicated at 140, illustrating implementation of the systems and methods of the present disclosure in a cloud computing environment. The system could be implemented in a non-production computing environment 144 which accesses a repository of models 142 generated in accordance with the present disclosure. Attributes and functions of the models 142 are discussed in detail below in connection with FIGS. 9-11. For univariate and majority estimate unit outputs, the models 142 can perform statistical analysis using interquartile range (IQR), and cluster can be calculated using Jaccard Similarity scores paired with unsupervised machine learning (hierarchical clustering) methods to create a static table of clusters. The clusters can then be used as static lookup tables. The models 142 could be accessed by a model deployment system 146, which distributes the models via cloud computing elastic container registry (ECR) 148 and a cloud formation component 150. The models are instantiated as application(s) 154, which are executed by the non-production computing environment 144 and are accessible via an API gateway 156. The API gateway 156 could allow access to lookup tables as well as machine learning models that can be inferenced for every API call. Examples of machine learning models that could be accessed using the API gateway 156 include Isolation Forests, Local Outlier Factor (LOF), and/or Angle-based Outlier Detection (ABOD). The applications 154 and models 142 can then be tested by approvers 156 and data scientists 158, so that the models 142 and applications 154 can be refined and improved. When they are ready for deployment, a machine learning operations team member 160 provisions access to the applications and models via a deployment system 164, which, along with the ECR 166 and cloud formation component 168, instantiates the applications and models on a production computing system 162 as application 170. Access to the application 170 by end-users 174 is then provisioned via the API gateway 172. It is noted that, at a regular cadence (e.g., bi-yearly or yearly), the various statistics and models implemented by the systems and methods of the present disclosure (including hierarchical models and API models, discussed above) could be refreshed with the most up-to-date data.

FIG. 8 illustrates screenshots of user interface screens generated by the systems and methods of the present disclosure. In the user interface screen 180, the system identifies the total number of violations, the total number of warnings, and the total number of cautions identified in the claims data, which are numeric tallies of the total number of anomalies identified in the claims data by the system. As can be seen in the screens 180 and 182, specific information about selected anomalies is displayed, as well as recommended actions to be taken to correct the anomalies (such recommended actions being automatically generated by the system in response to each detected anomaly). Also, using the “Dismiss” slider bars, the user can select to dismiss one or more of the displayed anomalies (e.g., if the user determines that a given anomaly is acceptable). As can be seen, anomalies (including quantity anomalies and cluster anomalies), group alerts, and estimate alerts can be generated by the system and displayed to the user.

FIGS. 9-11 are flowcharts illustrating overall processing steps carried out by the models 142 of the systems and methods of the present disclosure. In the flowchart 180 of FIG. 9, beginning in step 182, the system creates a base table. Then, in step 184, the system performs dimensional data analysis on the system. In this step, the system joins dimensioning data with the base table for analytic purposes. Next, in step 186, the system maps rare room types or loss types into large groupings. This is performed in order to avoid overfitting, as a model might learn details for a very small population that could not maintain the same trend in production. Sample groupings are illustrated in Tables 1 and 2, below, wherein Table 1 illustrates loss type groupings and Table 2 illustrates room type mappings generated by the system:

TABLE 1

| TYPE_OF_{—} | count(MASTER_{—} | | |
|---|---|---|---|
| LOSS_GROUP | FILE_NAME) | Percentage | Grouping |
| Water | 4916733 | 27.44% | Water |
| Wind | 4492999 | 25.07% | Wind |
| Hail | 3448031 | 19.24% | Wind/Hail |
| Wind/Hail | 1194986 | 6.67% | Wind/Hail |
| All Other | 1042501 | 5.82% | All Other |
| Hurricane | 658806 | 3.68% | Hurricane |
| Freeze | 542362 | 3.03% | Freeze |
| Fire | 505679 | 2.82% | Fire |
| Drain/Sewage | 214535 | 1.20% | Water |
| Vehicle | 193008 | 1.08% | All Other |
| Ice/Snow | 161987 | 0.90% | Freeze |
| Tornado | 134970 | 0.75% | Wind/Hail |
| Vandalism | 104757 | 0.58% | Theft/Vandalism |
| Theft | 99462 | 0.56% | Theft/Vandalism |
| Lightning | 76340 | 0.43% | Wind/Hail |
| Flood | 54754 | 0.31% | Water |
| Smoke | 50405 | 0.28% | Fire |
| Collapse | 26562 | 0.15% | All Other |

TABLE 2

| | | | Original |
|---|---|---|---|
| room_type_{—} | count(MASTER_{—} | | Room |
| grp | FILE_NAME) | Final Room | Type |
| Bath_Full | 3431132 | Bath | N |
| Entry | 983995 | Hall | N |
| Shed | 626610 | Accessory_Structures | N |
| Pantry | 379058 | Kitchen | N |
| Deck | 277757 | Attached_Structure | N |
| Porch | 189702 | Attached_Structure | N |
| Patio | 170129 | Attached_Structure | N |
| Sunroom | 102382 | Accessory_Structures | N |
| Walk_In | 72139 | Hall | N |
| Carport | 65033 | Accessory_Structures | N |
| Nook | 63702 | Living | N |
| Library | 11631 | Office | N |
| Screened_Lanai | 7189 | Attached_Structure | N |
| Greenhouse | 6735 | Accessory_Structures | N |
| ConferenceRoom | 6693 | Office | N |
| Unfinished | 4097 | Living | N |
| Show_Room | 3840 | Hall | N |
| Bath_Half | 2882 | Bath | N |
| Pool | 87 | Accessory_Structures | N |
| Sport_Court | 19 | Accessory_Structures | N |

Next, in step 188, the system performs a majority estimate unit analysis. There are situations where a user of the system enters a line item and estimate unit for that line item which does not match historical trends. To account for this, the system can detect the line item entered in an estimate, look up the entered estimate unit, and generate an alert if, historically, that estimate unit is not in line with the majority of estimate units (which could be an estimate unit that is used most for a given line item in the last 5 years).

In step 190, the system performs line item adjustment and univariate anomaly detection. The first second step in anomaly detection for residential estimates is to look at the quantity of a line item and determine if said quantity is anomalous to historical trends. Line items can have quality indicators as marked by trailing symbols (+, −, >, <, etc.). For univariate analysis on line item quantity, the system removes these quality indicators for a majority of line items and considers these line items to “adjusted.” The system then selects several line items where it is desired to consider the quality and not adjust said line items. The unadjusted line items are the line items adjusted for room/roof size.

When comparing quantities of a line item historically, it doesn't always make sense to compare a quantity outright with historical trends. For example, drywall quantities are directly related to the size of the room, and in such circumstances, it is desirable to adjust the quantity by the specific room dimension that is applicable. For example, for drywall, the system can divide by the wall square footage to get a quantity of drywall/square footage, and the result is deemed the “Adjusted Quantity.”

After adjusting the quality indicator for a select set of line items and adjusting the quantity by room size, the system analyzes the quantity distributions of adjusted/unadjusted line items. Investigating the last 5 years, the system can calculate the 10%, 25%, 50%, 75%, 90% percentiles for the quantity used for said line item. For each line item, the system can use an Inter Quartile Range (IQR) function to determine if that quantity inputted by the user is outside of a desired range (e.g., using 1.5 as a threshold). If the quantity/quantity adjusted is above or below the allowed range, it is considered anomalous. If the 25% and 75% percentiles of the historical quantity is the same, the line item quantity is anomalous if the quantity is lower than the 10% percentile or higher than the 90% percentile.

Finally, in step 192, the system performs line item association pattern matching. Because the system can access claims data containing a large number of residential estimates in the last 5 years, it is desirable to reduce the scope of estimates for the clustering approach implemented by the system. Also, it is desirable to focus in on line items that made up the top 80% of line item population, and to cluster those line items that show up the most, so as to reduce the computation time required.

As an example of the foregoing, the system can focus on estimates that occurred from 2021 Jan. 1 onwards, which reduces the estimate count to 8,848,982. Furthermore, a room can be filtered out of the data if it has a line-item count greater than 11 to help remove noise. Further the dataset can be made to only contain parameters such as MFN, room_type_grp, and line_item. Next, the system can create line-item and row identifiers (“IDs”). To create line-item IDs, distinct line-items are selected in alphabetical order, and each item is assigned a line-item number based on order. The line-item ID is then joined back to the dataset. For row ID, the data is grouped by mfn+room type group. First, they are aggregated by the count of distinct line-item IDs to get an item count for each row. Next, rows are ordered by room type group mfn+room type and assigned an ID. Finally, this data is joined back to the dataset and mapping out line-item and row IDs begins.

To complete distance metrics (Jaccard distances or Jaccard similarities) between line items, the system processes the data on a cloud computing (e.g., EC2 instance) with large memory capacities. For each line item, the system compares the MFN+Room Type Group (row_id's) to every other line item (534×534 comparisons). The data can be set up as a table of 534×534 rows, and the system can calculate the Jaccard similarity between these line items. The Jaccard similarity provides an indication of which line items are more similar to other line items based on the MFN+Room to which they belong.

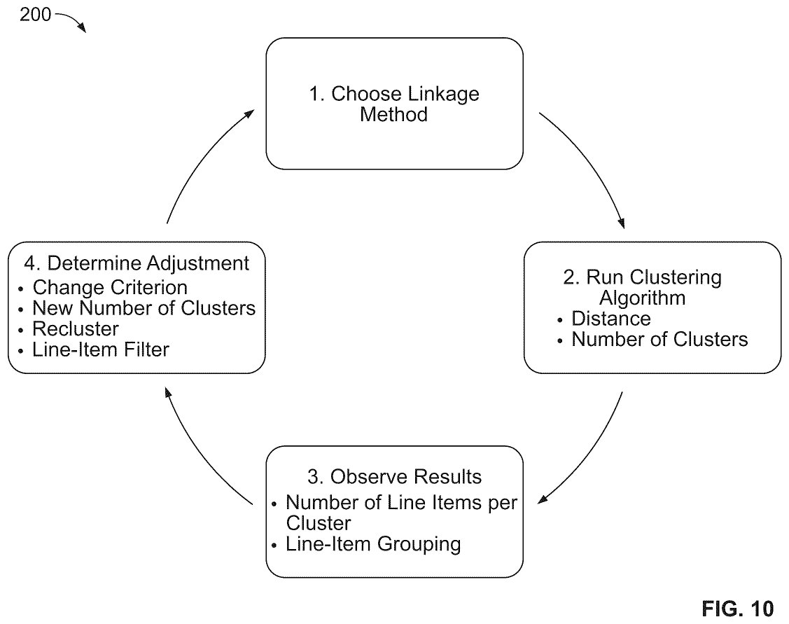

As shown in the flowchart 200 of FIG. 10, the system can formulate clusters of line items based on distance. The process begins by selecting a linkage method. Then, the system executes a clustering algorithm that can be adjusted based on the distance and number of clusters to be created. In the next step, the results of clustering are observed by the system. Finally, in the last step, the system determines and adjustment.

The clustering analysis can be performed according to the following filters and parameters: (1) the linkage method used is “ward” and (2) the criteria for clustering is “Numclust” 100, which means the data is split into 100 clusters. The system can also process 10, 25, 50, 75, 100, 111, 120 clusters to ascertain how the hierarchical cluster is behaving.

To begin clustering analysis, the system reads in both the base table filtered to only contain MFN, room_type_grp, and line_item, as well as the similarity scores produced in the Jaccard similarity step discussed above. Hierarchical clustering can be used various times to form groupings of line items. Different parameters can be used for some of the functions designed to implement clustering. Generally, the process involves the following steps: run linkage function for clustering, run fcluster to form desired hierarchical clustering based on some criteria, observe the results to get a sense of number of line items in a cluster (e.g., if clusters are reasonable, etc.), and then determining any needed adjustment(s).

To select a linkage method, cophenetic correlation and assessing dendrograms can be employed. For the first iterations, complete linkage can be used to lower the maximum inter cluster distances but ended up forming massive clusters with a large majority of items only going into one cluster. After trying different filters and clustering techniques, it was decided to check different types of linkage. Ward linkage were determined to be the best option due to the dendrograms having the most clearly formed and reasonable groupings. Weighted linkage eventually became the final type of linkage used because it had the best results after clustering: cluster sizes were appropriate, and the clusters contained the best groupings of items.

As for clustering techniques, both distance-based threshold and number of clusters can be used to attempt clustering. The threshold can be set based on the number of clusters desired. The number of clusters used by the system includes, but is not limited to, 10, 25, 50, 75, 100, 111 and 120. After defining the cluster methodology, clusters can then be assigned a label to ascertain what items fall within each cluster. Thereafter, using region, type of loss, and room type, a logical table for validating items can be provided.

The core indicator is assigned to the top few items in a cluster. The precise calculation is taken on a cluster-to-cluster basis, but a line item is assigned as a core item if the line item ratio >=average ratio per cluster+stdev ratios in cluster. The ratio per cluster is numMFN cluster/number of line items, and line item ratio is numMFN line item/numMEN cluster. A ratio greater than the standard deviation threshold means an item will be recommended/validated every time an item from its cluster appears and it is not there.

For type of loss and room, ratios are taken similar to the core. For each line item there are top 2 rooms and types of loss, with ratios of the numMFN for said type of loss or “Room” for the line item divided by total numMFN for the line item. For an item to be validated based on either of these criteria, first the top room or TOL must have a ratio >=the 65^{th} percentile of all of the top ratios within that group. For the second, the ratio must be above 65^{th} percentile of second ratios and also be greater than 0.20. The columns can either be blank, have one of either TOL or Room, respectively, or have two.

Regions are handled slightly differently, as it was decided to have the capacity for up to 3 regions per line item. These were based on overall averages of ratio, not by group. If the ratio for top region is >=75^{th} percentile regions assigned to a line item, the top region is used. If the 2^{nd} ratio is greater than the 25^{th} percentile of region ratios, and the sum of top and 2^{nd} region is greater than 65^{th} percentile, then two are used. Finally, if the third ratio is greater than or equal to the 50^{th} percentile (0.206,) then 3 regions are used. Combination output indicators are all then assigned into columns next to a line item and label, and this is the table used to validate items in an estimate.

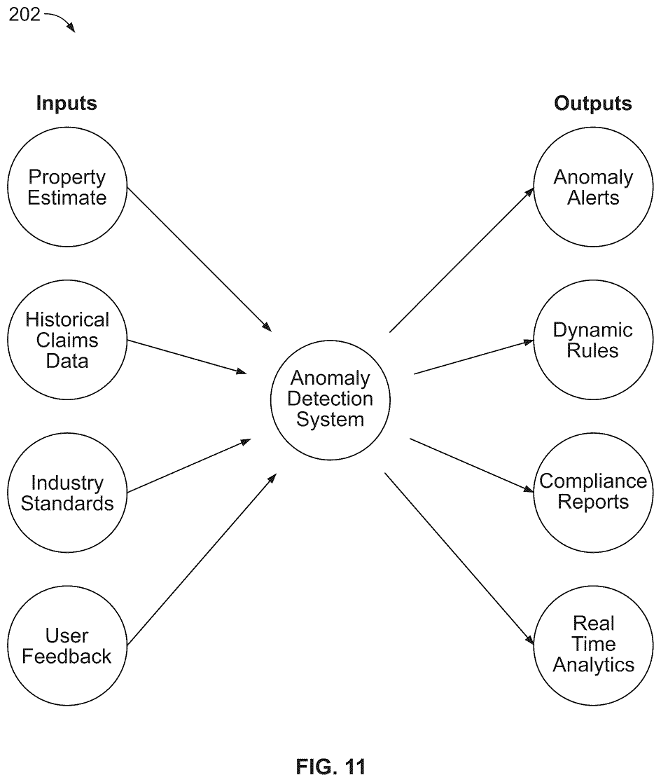

As shown in the flowchart 202 of FIG. 11, at a very high level, the system processes a plurality of inputs, such as property estimates, historical claims data, industry standards, and user feedback. It then generates a plurality of outputs, such as anomaly alerts, dynamic rules, compliance reports, and real-time analytics.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for property estimate anomaly detection, comprising;
a property claims processing platform; and
an anomalous line item detection engine, the engine causing the platform to:
receive property estimation data from a data source;
process the property estimation data to extract line item information from the property estimation data;
process the line item information and majority estimate information using a plurality of machine learning models to detect a majority estimate units, line item quantities, and line item clusters;
process the majority estimate units, the line item quantities, and the line item clusters to identify anomalous data in the line item information; and
generating and displaying a summary of the anomalous data in a graphical user interface screen of a claims estimate software application.

2. The system of claim 1, wherein the engine causes the platform to receive the property estimation data from the claims estimate software application.

3. The system of claim 1, wherein the engine causes the platform to receive the property estimation data from a property database server or one or more end-user computing devices in communication with the platform.

4. The system of claim 1, wherein the property estimation data comprises a real-time property estimate.

5. The system of claim 1, wherein the engine identifies the anomalous data by comparing the majority estimate units, the line item quantities, and the line item clusters to one or more analytic results performed on historical data.

6. The system of claim 5, wherein the engine identifies the anomalous data by identifying missing common line items.

7. The system of claim 1, wherein engine receive the property estimation data from the data source as a Javascript Object Notation (JSON) message transmitted to the platform as an Application Programming Interface (API) call to the platform.

8. The system of claim 7, wherein the engine generates and outputs the summary as a JSON output response.

9. The system of claim 1, wherein the engine identifies line item similarities in the line item information and scores the similarities.

10. The system of claim 1, wherein the plurality of machine learning models comprises isolation forest models, local outlier factor models, and angle-based outlier detection models.

11. The system of claim 1, wherein the summary identifies one or more of a total number of violations, a total number of warnings, and a total number of cautions identified by the engine.

12. The system of claim 11, wherein the summary includes at least one recommended action to correct an anomaly.

13. A machine learning method for property estimate anomaly detection, comprising;
receiving at a property claims processing platform property estimation data from a data source;
processing the property estimation data to extract line item information from the property estimation data;
processing the line item information and majority estimate information using a plurality of machine learning models to detect a majority estimate units, line item quantities, and line item clusters;
processing the majority estimate units, the line item quantities, and the line item clusters to identify anomalous data in the line item information; and
generating and displaying a summary of the anomalous data in a graphical user interface screen of a claims estimate software application.

14. The method of claim 13, further comprising receiving the property estimation data from the claims estimate software application.

15. The method of claim 13, further comprising receiving the property estimation data from a property database server or one or more end-user computing devices in communication with the platform.

16. The method of claim 13, wherein the property estimation data comprises a real-time property estimate.

17. The method of claim 13, further comprising identifying the anomalous data by comparing the majority estimate units, the line item quantities, and the line item clusters to one or more analytic results performed on historical data.

18. The method of claim 17, further comprising identifying the anomalous data by identifying missing common line items.

19. The method of claim 13, further comprising receiving the property estimation data from the data source as a Javascript Object Notation (JSON) message transmitted to the platform as an Application Programming Interface (API) call to the platform.

20. The method of claim 19, further comprising generating and outputting the summary as a JSON output response.

21. The method of claim 13, further comprising identifying line item similarities in the line item information and scores the similarities.

22. The method of claim 13, wherein the plurality of machine learning models comprises isolation forest models, local outlier factor models, and angle-based outlier detection models.

23. The method of claim 13, wherein the summary identifies one or more of a total number of violations, a total number of warnings, and a total number of cautions identified by the engine.

24. The method of claim 23, wherein the summary includes at least one recommended action to correct an anomaly.
